(19) United States
(12) Patent Application Publication
(10) Pub. No.: US 2014/0223328 A1
(43) Pub. Date: Aug. 7, 2014

(54) APPARATUS AND METHOD FOR AUTOMATICALLY CONTROLLING DISPLAY SCREEN DENSITY

(71) Applicant: Vishal Thomas, Karnataka (IN)

(72) Inventor: Vishal Thomas, Karnataka (IN)

(21) Appl. No.: 14/124,087

(22) PCT Filed: Nov. 23, 2012
(86) PCT No.: PCT/US2012/066449

§ 371 Date: Dec. 5, 2013

(30) Foreign Application Priority Data
Dec. 28, 2011 (IN) 3846/DEL/2011

(51) Int. Cl. G06F 3/0484

(52) U.S. Cl. CPC G06F 3/0484
USPC 715/747

(57) ABSTRACT

An apparatus for controlling a screen includes a storage area, an analyzer, and a controller. The storage area stores information indicative of one or more screen usage attributes. The analyzer determines a pattern of usage based on the stored information. The controller automatically changes a density of the screen from a first density to a second density based on the pattern of usage determined by the analyzer. The change to the second density produces a change in a size of one or more items displayed on the screen.

### FIELD

One or more embodiments described herein relate to controlling a display screen.

### BACKGROUND

Smart phones, tablets, notebook computers, and other electronic devices have display screens set to standard factory settings. These settings include screen density, which is generally measured in terms the number of dots (pixels) per inch or by some other metric and which is related to screen resolution.

To provide consumers with large amounts of information at a given time, the screen density on these devices is usually set to a high setting. This setting, however, may not be suitable for some users, especially those with large fingers, poor eyesight, or who otherwise have difficulty performing touch, stylus, or mouse inputs. For these users, attempts at selecting small-sized icons, links, or other functions may result in errors, e.g., selecting an unintended icon or link.

On some devices, it may be possible to manually manipulate screen size in order to make icon selection easier. However, the time and inconvenience involved complicates use of the device and may cause additional inaccuracies and mistakes. Also, on these devices, a manual manipulation is required each time a user accesses the same website or application.

### BRIEF DESCRIPTION OF THE DRAWINGS

FIG. 1 shows one embodiment of an apparatus for controlling a screen.

FIG. 2 shows an example of stored screen usage attributes.

FIG. 3 shows an example how an unintended touch input may be entered.

FIG. 4 shows one example of how a screen density change may be performed.

FIG. 5 shows another example of how a screen density change may be performed.

FIG. 6 shows pre-stored density values for changing screen density.

FIG. 7 shows one embodiment of a method for controlling a display screen.

### DETAILED DESCRIPTION

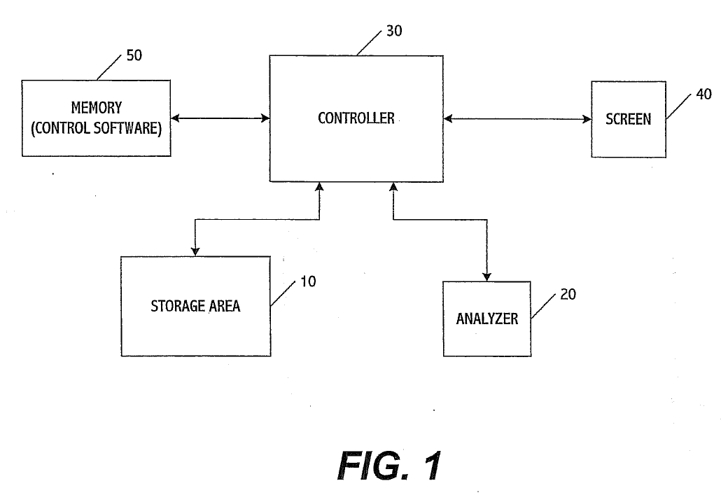

FIG. 1 shows an embodiment of an apparatus for controlling a screen of an electronic device. The screen may be included in a same housing of the device or the screen may be coupled to the device through an appropriate wired or wireless interface. Examples of the device include a smart phone, tablet, pod-type terminal, electronic reader, game terminal, remote-controller, camera, appliance, digital recorder, global-positioning terminal, notebook or desktop computer, or media player, as well as any other electronic device that operates to display information on a screen.

The apparatus includes a storage area 10, and analyzer 20, and a controller 30.

The storage area 10 stores information indicative of one or more screen usage attributes. The attributes may correspond to one or more types of actions performed in displaying information and/or one or more types of actions performed in executing functions based on selected displayed information. According to one embodiment, the screen usage attributes may correspond to different ways commands are entered based on the information displayed on screen 40.

Examples of commands that correspond to screen usage attributes include touch inputs made by a finger, stylus, or mouse, drag-and-drop operations, move operations, swipe actions used to contract or expand screen size or ones to perform other screen-specific functions, and/or activation of one or more keys or buttons for affecting the display of information or performing a function, to name few.

The touch inputs may be used, for example, to select a link, activate a selectable icon, input text or numbers using an electronic keyboard displayed on the screen (where mistakes are constantly made while entering individual letters), and/or perform a text or website editing function (e.g., copy, cut, and/or paste an image or text).

The screen usage attributes may be stored under control of controller 30 or another processor of the electronic device. In accordance with one embodiment, the attributes are stored using control software 50 resident within the device, for example, in a read-only or other type of internal memory. The control software cause's the storage area to store information indicative of the types of user inputs made during operation over a predetermined period of time. The time period may be programmed into the control software and may or may not be adjusted by a user, for example, through the use of a control menu.

In accordance with one embodiment, the control software causes the storage area to store screen usage attributes for only a certain mode of operation of the electronic device. The mode may correspond to when an internet website is accessed, either directly or through the use of a browser. In this mode, the storage area may store information indicating the types of commands entered. The commands may be entered based on touch inputs or any of the other input techniques previously described, e.g., mouse inputs, inputs made though the pressing or activation of a key or button, or voice command inputs as well as other input techniques.

According to one technique, the command software may control the storage area to store information identifying the commands entered for all websites accessed and for all browser use. Alternatively, the command software may control the storage area to store information identifying the entered command for only one or more predetermined websites. The predetermined websites may correspond, for example, to a specific category of websites (e.g., news, sports, streaming media, social networking, etc.) or to specific websites that have been identified. A control menu may be displayed beforehand to allow a user to specify the specific or category of websites for which screen usage inputs (commands) are to be monitored

Another mode of operation corresponds to the use of one or more applications, such as those found on a smart phone or pod/pad-type device. During this mode, the controller may control the storage area to store screen usage attributes relating to the applications to be executed on the electronic device. As in previous embodiments, the attributes may correspond to commands entered by touch input, key/button input, voice input, etc.

The command software may control the storage area to store information identifying these commands for all executable applications or one or more predetermined applications. The predetermined applications may, for example, correspond to a specific category of applications (e.g., utilities, media, social networking, finance, games, medical, etc.) or to specific applications that have been identified. A control menu may be displayed beforehand to allow a user to specify the specific or category of applications for which screen usage inputs (commands) are to be monitored.

In accordance with another embodiment, the screen usage attributes may correspond to commands entered in for a plurality of operational modes. By storing screen usage attributes in this manner, the storage area will compile a statistical base of data which can be used by the analyzer to identify usage patterns in a manner to be described in greater detail. According to one embodiment, a sequential list of input commands corresponding to the screen usage attributes may be stored in the storage area.

Optionally, the controller may cause the storage area to store information indicative of other information, including but not limited to the time difference (Δ) between input commands, the website or application corresponding to each input command, and/or the execution results of the commands. In accordance with one embodiment, this additional information may assist the analyzer in determining whether an invalid input or valid input was made each time a command was entered (e.g., for each screen usage attribute). Alternatively, the analyzer may determine whether a valid or invalid entry was made based solely on the sequential list of commands.

The execution results may include, for example, information indicating whether a command was a valid or invalid input. An invalid input may, for example, access an unintended website or application and/or may correspond to the case where no action was taken. The latter situation may arise when, for example, the touch input failed to select a link on the screen, because, for example, the user's finger touched a portion of the screen adjacent the link that corresponds to an unselectable inactive area. Detection of a valid or invalid input may be determined, for example, by the controller and/or analyzer.

The analyzer 20 performs the function of analyzing the information in the storage area. In performing this function, the analyzer may be programmed to identify specific patterns of usage from the stored information that arise when a command or other type of screen usage attribute produced an invalid input. The analyzer may be implemented, for example, by statistical or data analysis software. This software stored in memory 50 or another memory, e.g., one on the same chip as the controller.

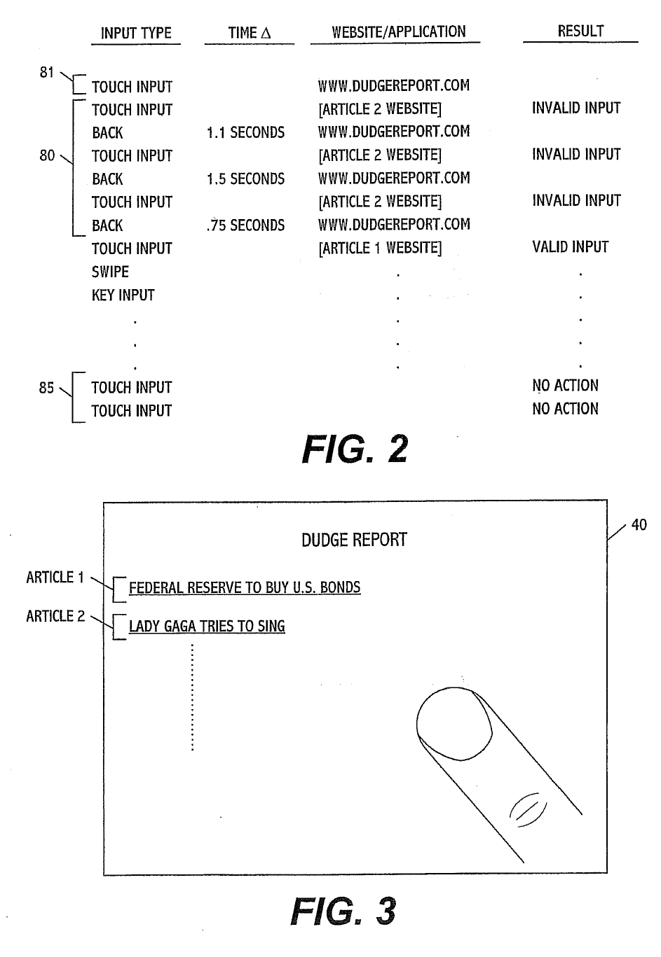

An example of how the analyzer may identify valid and invalid inputs based on patterns of usage is discussed relative to FIGS. 2 and 3. In FIG. 2, a partial list of screen usage attributes stored in storage area 10 is provided. These attributes include a sequential list of input commands entered over a predetermined period of time, e.g., a learning period of one week. In this list, a repetitive pattern of “touch input” and “back” commands is stored, as shown by region 80. This pattern may occur, for example, when a user intended to touch one link or selectable icon on a displayed webpage but instead actually touched another link or icon, or completely missed touching any active area on the page.

Such a case may arise when the original screen density causes the link or icon to be too small in comparison to the size of a user's finger in order to make an accurate selection, or touch input. Also, when screen density is too high, a person may be unable to touch an intended link or icon as a result of poor eyesight or because of a poor interface screen design.

FIG. 3 provides an example of this situation. In this figure, two links are shown that respectively correspond to Article 1 and Article 2. Because of the large size of the user's finger coupled with the high screen density, a touch input by the user may mistakenly select the link for Article 2, when the link for Article 1 was intended. The control software of the analyzer may be programmed to identify a re-occurring pattern of three successive invalid touch inputs, for purposes of identifying a pattern of usage that identifies an invalid input.

According to one technique, when this repetitive pattern occurs a predetermined number of times over the one-week period, action may be taken by the controller to automatically change the screen density. The density change may be performed for this website only or generally for all websites to be displayed on the screen. A similar set of control operations may be performed for identifying patterns of usage from an analysis of screen usage attributes relating to an application.

According to another technique, a pattern of usage may be recognized based on other screen usage attributes in the storage area. This additional attributes may include time difference (Δ) and website/application information. The time difference information may provide an indication of time between successive touch input commands, and the website/application information may identify the websites and/or applications accessed by a user during the learning time period.

FIG. 2 provides an example of these additional screen-usage attributes and how they may be used as a basis for identifying a pattern of usage. When the time difference between a successive, repetitive pattern of “touch input” and “back” commands is below a predetermined limit (e.g., 2 seconds), the analyzer may be programmed to identify a pattern of usage of invalid touch inputs. The shortness of this time limit suggests that the user has selected the wrong link and has quickly attempted to correct the problem by touching the Back button or arrow, so that he may try once again to select the correct link. Another pattern of usage may correspond to one or more successive input commands (whether by touch, stylus, or mouse) which produces no action at all, as shown by region 85 in FIG. 2.

When these or other patterns of usage have been identified a predetermined number of times during the learning time period, action may be taken by the controller to automatically change the screen density. This decision may be made in a variety of ways.

One way involves receiving information from the analyzer indicating the number of invalid inputs and the number of valid inputs that have occurred over the learning time period. This may be performed on a website-by-website basis, an application-by-application basis, or both, or generally for all websites and/or all applications. Based on this information, the screen density may be changed by the controller, either for specific ones of the websites or applications for which the erroneous usage pattern has been repeated for more than the predetermined number of times, or for all websites and/or applications in general. The analyzer may also optionally control the storage area to store corresponding information identifying invalid and/or valid inputs.

Also, in the foregoing examples, the screen usage attributes and patterns of usage were discussed relative to the selection of links or icons. In other embodiments, screen usage attributes and patterns of usage may be identified for other types of commands, including but not limited to attempts at selecting text to be cut, copied, and pasted, swipes to cause different information within a same page to be displayed or different pages to be displayed, screen expansion or contraction touches or move operations as well as others.

In accordance with one embodiment, a valid input may be determined to occur when an intended action is accomplished on a first attempt, e.g., an intended website was accessed based on only one touch input to that link. Thus, for example, in FIG. 2, the website “dudgereport.com” was accessed based on only one touch input 81. Appropriate monitoring software may be used to determine when the valid and invalid inputs occur.

The controller 30 performs one or more screen control functions based on a pattern of usage identified by the analyzer. The screen control functions include automatically changing a density of the screen from a first density to a second density based on the identified pattern(s) of usage. The screen density may be changed on a website-by-website basis, application-by-application basis, and/or generally for all websites and/or applications.

According to a website-by-website implementation, the controller receives from the analyzer information indicative of the number of valid inputs that have been identified for a particular website and the number of invalid inputs that have been identified for a particular website during the predetermined (learning) period. As previously indicated, the invalid inputs correspond to patterns of usage identified by the analyzer, e.g., ones corresponding regions 80 and 85.

Additionally, or alternatively, the controller may receive from the analyzer information indicative of the number of valid input episodes and the number of invalid input episodes that have been identified during the predetermined (learning) period. For the sake of clarity, an episode may collectively refer to the identification of a usage pattern that contains invalid inputs. Thus, in FIG. 2, region 80 may be considered to have three invalid inputs but only one invalid input episode.

When this information is received from the analyzer, the controller performs a comparison of the numbers to one or more predetermined threshold values. According to one implementation, the controller may compute a ratio of these numbers for comparison to a predetermined threshold value. Based on this comparison, the controller will either automatically perform a screen control function or will not perform this function. For example, if the ratio is greater than a value of 1, then more invalid inputs (or episodes) occurred during the learning period that valid inputs (or episodes). In other embodiments, the threshold value may be less than one.

According to another implementation, the controller may compare only the number of invalid inputs (or input episodes) for the particular website, and then automatically perform or not perform a screen control function based on the comparison.

According to another implementation, the controller receives from the analyzer information indicative of the number of valid inputs (or episodes) and the number of invalid inputs (or episodes) for all websites accessed during the predetermined (learning) period. The controller may then perform a compute a ratio of these numbers for comparison to a threshold value, or may only compare the number of invalid inputs (or episodes) to a threshold. Similar implementations may be performed for a particular application or group of applications, or generally for all applications.

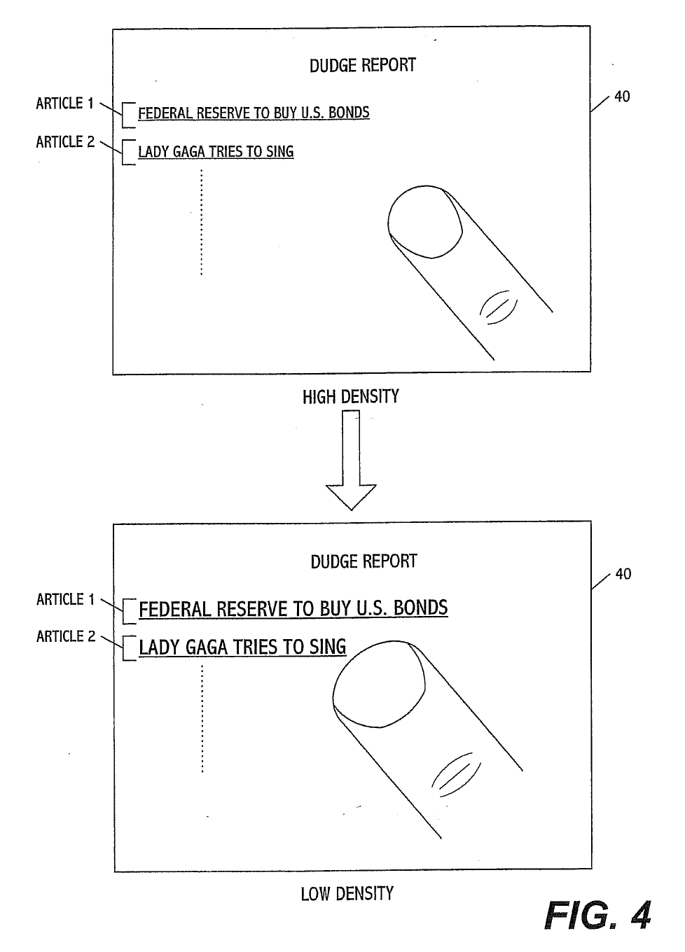

The change in screen density performed by the controller may be accomplished by automatically setting a default value in a setting menu that corresponds to the adjusted density. The adjusted density may produce a change in the size of the information displayed on the screen. For example, as shown in FIG. 4, when the screen density is changed to a lower value, the links corresponding to Articles 1 and 2 become larger, thereby making it easier for the user to select the intended link with a finger, stylus or cursor. The change in screen density may also produce a change in screen resolution. In other embodiments, the controller may change the screen to a higher value, to produce a commensurate change in the size of the information displayed on the screen.

In the foregoing embodiments, the analyzer and controller were described to control the display of information for websites or applications. In other embodiments, the analyzer may identify patterns of usage and the controller may control screen density for information displayed in a control screen, management screen, or menu of an electronic device.

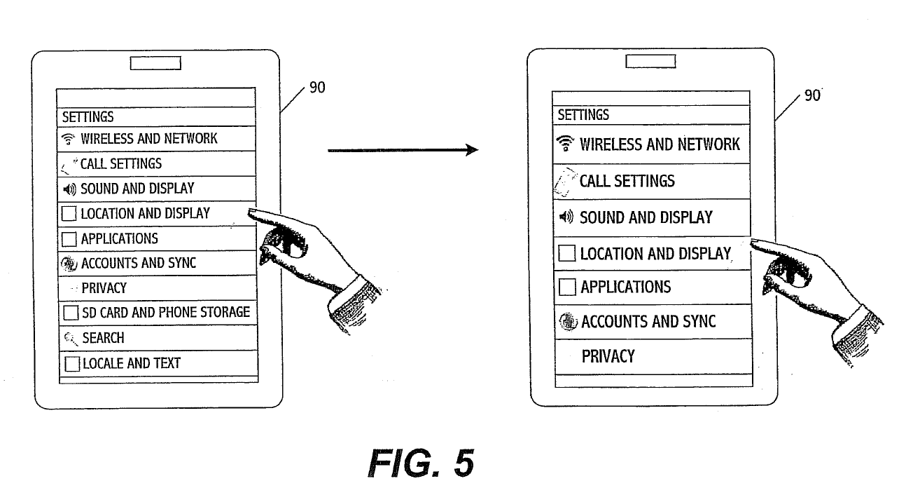

FIG. 5 shows an example of the case where the controller changes the screen density of a settings menu 90 displayed on a mobile terminal from a higher density to a lower density. While this change causes a portion of the settings menu to be left out, the size of the menu is increased to allow for easier and more accurate touch selection of the items in the portion that is displayed.

Also, in FIG. 5, the menu is show to correspond to the limits of the screen. However, in other embodiments, the menu may be smaller than the physical dimensions of the screen. In this case, the controller may only control the screen density of information shown in the menu, with the screen density of other portions of the screen left unadjusted.

Also, the controller may change screen density selectively for only portions of a screen that do not relate to menus, such as, for example, chat message windows, address entry windows for entering email or text message addresses, windows or areas used for social networking or receipt of notification messages, video or media player regions, images, as well as sub-areas dedicated to displaying other types of information on the screen.

The change in screen density to be performed by the controller may be accomplished based on one or more predetermined density values stored in memory for purpose of improving the ease of use of making inputs by a user or for other reasons. For example, in accordance with one embodiment, a plurality of different density values may be stored in memory for selection by the controller. The selection may be performed based on a comparison to predetermined threshold value(s) as previously discussed.

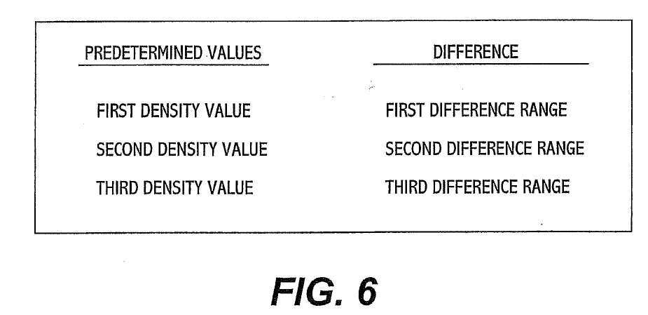

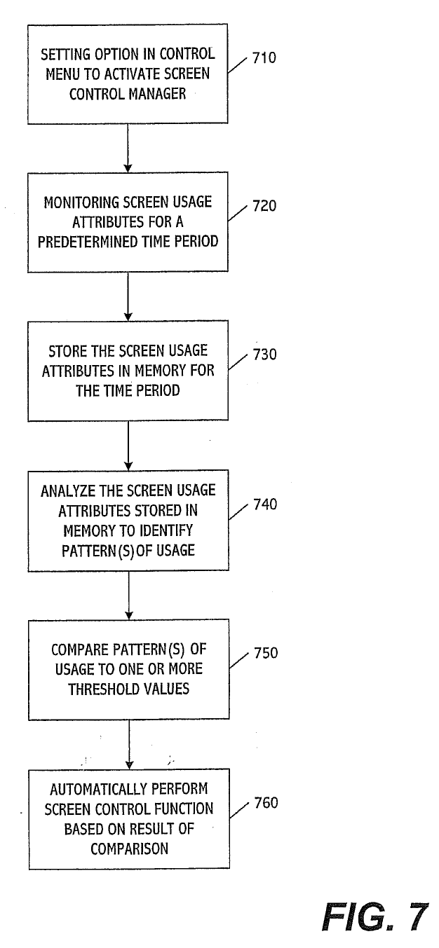

For example, as shown in FIG. 6, if the comparison shows a difference lying in a first range, the controller may select a first one of the predetermined density values for changing screen density. If the comparison shows a difference lying in a second range different from the first range, then the controller may select a select a second one of the density values for changing screen density, and so on.

In accordance with another embodiment, the change in screen density may be performed based on an adjusted pixel density computed by the controller (or analyzer). The adjusted pixel density may be considered to be equivalent to a change in screen resolution computed in accordance with Equations (1)-(4):

DP=\sqrt{Wₚ²−+‥Hₚ^{2′}} (1)

where DP corresponds to a diagonal resolution of the screen measured in pixels, Wₚ corresponds to the display resolution width, and Hₚ corresponds to the display resolution height.

Current Pixel Density=DP/PS (2)

where the Current Pixel Density may be measured in pixels per square inch and PS corresponds to the physical side of the screen.

Invalid Input Ratio=Invalid Inputs/Total Inputs (3)

Adjusted Pixel Density=Current Pixel Density*K(Invalid Input Ratio+1) (4)

where K is a predetermined constant value set by the user or control software for the screen.

These equations may be used in accordance with the following example for purposes of changing the density (and thus resolution) of a screen of an iPhone 3 GS model. For this phone, consider the case where the display resolution width is 480 pixels and the display resolution height is 320 pixels, or vice versa. Based on Equation (1), the diagonal resolution of the screen is 576 pixels.

The physical size of the screen is 3.5 inches (measured on the diagonal). Based on Equation (2), the current pixel density is 164.5714 pixels per inch.

Using a touch screen device driver hook, the touch screen inputs are monitored to be as follows for a predetermined (learning) time period equal to 2 days. The even ACTION_DOWN refers to a touch input made by one finger and the numbers separated by a comma refer to the x and y screen coordinate positions where the touch occurred.
1. event ACTION_DOWN [#0(pid 0)=135,179]: No view implemented in the application screen for this event. Hence, an invalid input. Increment Invalid Input count by 1.
2. event ACTION_DOWN [#0(pid 0)=135,184]: Valid view implemented. Thus, a valid input. Increment total input count by 1.
3. event ACTION_DOWN [#0(pid 0)=144,205]: Valid view implemented. Thus, a valid input. Increment total input count by 1.
4. event ACTION_DOWN [#0(pid 0)=152,227]: Valid view implemented. Thus, a valid input. Increment total input count by 1.

The foregoing data includes touch inputs as screen usage attributes, and the pattern of usage corresponds to whether those inputs are valid or invalid. For the period for which the four usage attributes were stored in memory, there was 1 touch input that produced an invalid result out of a total of 4 touch inputs. Based on Equation (3), the invalid input ratio is 0.25. In other words, 25% of all the touch inputs by the user had to be corrected by repeating the touch input action.

With this information known, the adjusted screen density may now be computed based on Equation (4), where K=1:

Adjusted Pixel Density=164.5714*(0.25+1)*1=205.7143

Thus, in this example, the controller changes the screen density from the initial value of 164 to 205 pixels per inch. Given this adjusted density and maintaining the aspect ratio of the screen, the new screen resolution may be determined and set. As a result, the size of the items (text, icons, links, images, etc.) on the screen may be increased (or decreased), for example, based on the specific characteristics (e.g., finger size) of the user.

The screen control function automatically performed by the controller has been identified as a change in screen density. However, in other embodiments, the controller may automatically perform additional or different screen control functions based on the pattern of usage information output from the analyzer. These additional or different functions may include changing a background or foreground font color of the screen or different portions of the screen, changing the color or appearance of text, icons, or other information on the screen, and/or changing a font size of text on the screen.

Also, the controller has been described as computing the ratio and/or performing the threshold-value comparison for purposes of determining whether to automatically perform a screen control function. However, in other embodiments, the analyzer may perform this function and inform the controller of the result.

FIG. 6 shows operations performed in accordance with one embodiment of a method for controlling a display screen of an electronic device. The device may correspond to any of those previously mentioned, including ones that either include or are coupled to the screen.

The method includes setting an option in a control menu of an electronic device that includes or is coupled to the screen. The option in the control menu turns on or otherwise activates a screen control manager for automatically performing a screen control function based on screen usage. (Block 710). The screen control manager may correspond to all or portion of the apparatus in FIG. 1 or another apparatus. (The operation in Block 170 may be optional, as the device may be set by the factory to automatically perform the method without user interaction).

After the screen control manager has been set, screen usage attributes begin to be monitored for a predetermined period of time. (Block 720). The screen usage attributes may be one or more predetermined types or may be all screen usage attributes entered into the electronic device. The attributes correspond to any of the types previously discussed, including but not limited to various input or other commands. The commands may be entered using touch inputs, swipes, drag-and-drop operations, expansion or contraction operations, stylus inputs, cursor entries, voice commands, or other types of inputs or commands including those detected by so-called tactile sensors, image or voice recognition systems, or based on wireless and/or remote control signals.

The types of screen usage attributes may be recognized, for example, by system operating software and information identifying the screen usage attributes is stored in memory, as previously discussed. (Block 730). Examples of stored screen usage attributes are shown in FIG. 2. The predetermined time for monitoring and storing operations of the screen usage attributes may be a fixed period of time set in the system operating software or may be a time adjustable by a user, for example, by accessing a corresponding control menu setting. According to one embodiment, the time period may be continuous with no stop period.

Additionally, the time period may be considered to be a leaning time period, after which an assessment is made for purposes of performing a screen control function. Also, the screen usage attributes may be performed on a website-by-website basis, application-by-application basis, a combination thereof, or generally for all websites and/or applications accessed over the learning time period.

The screen usage attributes stored in memory is analyzed to identify one or more patterns of usage. (Block 740). The analysis may be performed in a manner similar to the operations of the analyzer in FIG. 1 previously discussed. Moreover, the stored attributes may be analyzed continuously or intermittently throughout the learning period, or the analysis may be performed after the learning period has expired.

Once the pattern(s) of usage have been identified, a decision is made as to whether to perform a screen control function. The screen control function may be automatically performed seamlessly and without user input (perhaps, with the exception of the initial activation setting in Block 710. In other embodiments, no such setting may be required but rather the screen control function may be automatically set by system software without requiring any user intervention.)

In accordance with one embodiment, the decision as to whether to perform a screen control function is based on a comparison of the usage pattern(s) to one or more predetermined threshold values. (Block 750). For example, as previously indicated, a ratio may be computed based on the number of invalid inputs and the number of valid inputs for a given website or application (or generally for all websites and/or applications). If the ratio is greater than a predetermined value (with the number of invalid inputs being divided by the number of valid inputs), then the screen control function may be automatically performed after the learning time period expires. Alternatively, the decision on whether to perform a screen control function may be based solely on the number of invalid inputs compared to a threshold value.

The screen control function is performed based on a result of the decision, e.g., comparison. (Block 760). As previously indicated, the screen control function may be automatically performed under these circumstances and may involve changing a density of the screen from a first density to a second density based on the pattern of usage. This change may produce a corresponding change in the size of one or more links, icons, images, video, graphical objects, text, or other items displayed on the screen. The change in screen density may be performed for the entire screen or selectively for only one or more portions of the screen, with the screen density of other portions left undisturbed.

The screen control function may also include a change in other screen parameters. For example, as previously discussed, these parameters may include background or foreground color and/or font size, as well as other adjustable parameters of the screen.

Another embodiment corresponds to a computer-readable medium storing a program for performing operations of the one or more embodiments of the method described herein. The program may be part of the operating system software or may be a separate application to be executed by a central processing unit or controller of the electronic device. The medium may be a read-only memory, random access memory, flash memory, disk, or other article capable of storing information. Also, the program may be executed remotely using, for example, a cloud-type processor or through software downloaded for execution through a wired or wireless link.

According to another embodiment, the data in storage area 10 may alternatively or redundantly be stored in a remote medium, such as a cloud-type storage device in communication with the electronic device. Also, in FIG. 1, the controller and analyzer are shown to be separate components. However, in other embodiments, the analyzer may be included within the controller. For example, the same control software may perform the functions of analyzer and controller as previously described herein.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Also, the features of any one embodiment described herein may be combined with the features of one or more other embodiments to form additional embodiments.

Furthermore, for ease of understanding, certain functional blocks may have been delineated as separate blocks; however, these separately delineated blocks should not necessarily be construed as being in the order in which they are discussed or other wise presented herein. For example, some blocks may be able to be performed in an alternative ordering, simultaneously, etc

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. An apparatus for controlling a screen, comprising:
a storage area to store information including one or more screen usage attributes;
an analyzer to determine a pattern of usage based on the stored information; and
a controller to automatically change the screen from a first density to a second density based on the pattern of usage to be determined by the analyzer, wherein the change to the second density is to produce a change in a size of one or more items to be displayed on the screen.

2. The apparatus of claim 1, wherein the one or more items to be displayed on the screen include at least one of text, an image, video information, or an icon.

3. The apparatus of claim 1, wherein the change to the second density is to be performed for a website.

4. The apparatus of claim 1, wherein the change to the second density is to be performed for an application.

5. The apparatus of claim 1, wherein the one or more screen usage attributes correspond to one or more types of actions to display information or execute a function, or both.

6. The apparatus of claim 5, wherein the one or more types of actions correspond to at least one of a touch input, mouse input, key or button input, or voice command input.

7. The apparatus of claim 1, wherein the pattern of usage to be determined by the analyzer corresponds to at least one of a number of invalid input(s), a number of valid input(s), or a total number of input(s) to be received during a predetermined period of time.

8. The apparatus of claim 7, wherein the controller is to change the density of the screen from the first density to the second density based on a ratio of the number of invalid input(s) and the number of valid input(s) determined over the predetermined period of time.

9. The apparatus of claim 8, wherein the controller is to change the density of the screen from the first density to the second density based on a comparison of the ratio to a predetermined threshold value.

10. The apparatus of claim 1, wherein the second density is lower than the first density.

11. The apparatus of claim 1, wherein the analyzer is located in the controller.

12. The apparatus of claim 1, wherein the controller is to control the storage area to store information indicative of the one or more screen usage attributes for only Internet websites.

13. The apparatus of claim 1, wherein the controller is to control the storage area to store information indicative of the one or more screen usage attributes for only applications.

14. The apparatus of claim 1, wherein the controller is to determine the second density based on a product of the first density and a correction factor, and wherein the correction factor is to be determined based on the pattern of usage.

15. A method for controlling a screen, comprising:
storing information including one or more screen usage attributes;
determining a pattern of usage based on the stored information; and
automatically changing a density of the screen from a first density to a second density based on the pattern of usage, wherein the change to the second density produces a change in a size of one or more items displayed on the screen.

16. The method of claim 15, wherein the one or more screen usage attributes correspond to one or more types of actions to display information or execute functions, or both.

17. The method of claim 15, wherein the pattern of usage corresponds to at least one of a number of invalid input(s), a number of valid input(s), or a total number of input(s) received over a predetermined period of time.

18. The method of claim 17, wherein the density of the screen is changed from the first density to the second density based on a ratio of the number of invalid input(s) and the number of valid input(s) determined over the predetermined period of time.

19. The method of claim 18, wherein the density of the screen is changed from the first density to the second density based on a comparison of the ratio to a predetermined threshold value.

20. The method of claim 15, wherein the second density is lower than the first density.

21. The method of claim 15, wherein the change to the second density is performed for at least one of a website or an application.

22. A non-transitory computer-readable medium storing a program for controlling a display screen, the program including:
first code to store information including one or more screen usage attributes;
second code to determine a pattern of usage based on the stored information; and
third code to automatically change a density of the screen from a first density to a second density based on the pattern of usage, wherein the change to the second density is to produce a change in a size of one or more items displayed on the screen.

23. The computer-readable medium of claim 22, wherein the one or more screen usage attributes correspond to one or more types of actions to display information or execute functions, or both.

24. The computer-readable medium of claim 22, wherein the pattern of usage is to correspond to at least one a number of invalid inputs, a number of valid inputs, and a total number of inputs.

25. The computer-readable medium of claim 24, wherein the density of the screen is to be changed from the first density to the second density based on a ratio of the number of invalid inputs and the number of valid inputs determined over a predetermined period of time.

26. An apparatus for controlling a screen, comprising:
a storage area to store screen usage attributes; and
a controller to determine a pattern of usage based on the stored screen usage attributes and to automatically perform a screen control function based on the pattern of usage, wherein the screen control function is to change an appearance of one or more items displayed on the screen.

27. The apparatus in claim 26, wherein the screen control function is to include changing a density of the screen from a first density to a second density, and wherein the change to the second density is to produce a change in size of the one or more items displayed on the screen.

28. The apparatus of claim 26, wherein the pattern of usage is to correspond to at least one of a number of invalid input(s), a number of valid input(s), or a total number of input(s).

29. The apparatus in claim 28, wherein the controller is to perform the screen control function based on a comparison of at least one of the number of invalid input(s), the number of valid input(s), or the total number of input(s) to a predetermined threshold value.

30. The apparatus of claim 30, wherein the storage area is to store the screen usage attributes for at least one of a website or application, and wherein the controller is to perform the screen control function for said at least one website or application.
